(19) United States
(12) Patent Application Publication
(10) Pub. No.: US 2026/0208618 A1
(43) Pub. Date: Jul. 23, 2026

(54) SYSTEMS AND METHODS FOR MANAGING REGENERATIVE ENERGY IN A VEHICLE

(71) Applicant: GM GLOBAL TECHNOLOGY OPERATIONS LLC, Detroit, MI (US)

(72) Inventors: Yongjie Zhu, Troy, MI (US); Chunhao J. Lee, Troy, MI (US); Norman K. Bucknor, Troy, MI (US); Su-Yang Shieh, Clawson, MI (US); Jun-mo Kang, Ann Arbor, MI (US); Shobhit Gupta, Sterling Heights, MI (US); Wesley Gerard Zanardelli, Rochester, MI (US)

(73) Assignee: GM GLOBAL TECHNOLOGY OPERATIONS LLC, Detroit, MI (US)

(21) Appl. No.: 19/032,862

(22) Filed: Jan. 21, 2025

(51) Int. Cl. B60L 58/12; B60H 1/32; B60L 1/02; B60L 7/10; H02J 7/14; H02J 7/16

(52) U.S. Cl. CPC B60L 58/12; B60H 1/3205; B60L 1/02; B60L 7/10; H02J 7/1423; H02J 7/16; B60L 2240/545

(57) ABSTRACT

A regenerative energy notification associated with regenerative energy being generated in response to braking of a vehicle using a regenerative braking system is received from an electronic brake control module (EBCM) of the vehicle. A state of charge (SOC) of a high voltage (HV) battery of a vehicle battery system is received from the vehicle battery system. A determination is made regarding whether the SOC of the HV battery is greater than a low SOC threshold. A command is issued to a vehicle integration control module (VICM) to route the regenerative energy from a vehicle electric motor operating as a generator of the regenerative energy to power at least one of a vehicle heating, ventilation, and cooling (HVAC) system, a vehicle battery cooling system, and at least one vehicle accessory system based on the determination.

### INTRODUCTION

The technical field generally relates to vehicles, and more particularly relates to systems and methods for managing regenerative energy in a vehicle.

Many vehicles include regenerative braking systems. A regenerative braking system captures vehicle kinetic energy generated during braking of a vehicle and converts the vehicle kinetic energy into electrical energy. The converted electrical energy is referred to as regenerative energy.

Accordingly, it is desirable to provide systems and methods for managing regenerative energy of a vehicle. Other desirable features and characteristics will become apparent from the subsequent detailed description and the appended claims, taken in conjunction with the accompanying drawings and the foregoing technical field and background.

### SUMMARY

A regenerative energy management system for a vehicle includes at least one processor and at least one memory communicatively coupled to the at least one processor. The at least one memory includes instructions that upon execution by the at least one processor, causes the at least one processor to: receive a regenerative energy notification associated with regenerative energy being generated in response to braking of the vehicle using a regenerative braking system from an electronic brake control module (EBCM) of the vehicle; receive a state of charge (SOC) of a high voltage (HV) battery of a vehicle battery system from the vehicle battery system; determine whether the SOC of the HV battery is greater than a low SOC threshold; and issue a first command to a vehicle integration control module (VICM) to route the regenerative energy from a vehicle electric motor operating as a generator of the regenerative energy to power at least one of a vehicle heating, ventilation, and cooling (HVAC) system, a vehicle battery cooling system, and at least one vehicle accessory system based on the determination.

In at least one embodiment, the at least one memory further includes instructions that upon execution by the at least one processor, causes the at least one processor to: receive an ambient air temperature from a sensor system of the vehicle; determine whether the ambient air temperature is less than a low ambient air temperature threshold or greater than a high ambient air temperature threshold, the high ambient air temperature threshold being higher than the low ambient air temperature threshold; and issue the first command to the VICM to route the regenerative energy from the vehicle electric motor operating as the generator of the regenerative energy to power the vehicle HVAC system based on the determination.

In at least one embodiment, the at least one memory further includes instructions that upon execution by the at least one processor, causes the at least one processor to: make a first determination regarding whether the ambient air temperature is greater than the low air temperature threshold and less than the high ambient air temperature threshold; make a second determination regarding whether the SOC of the HV battery is greater than a high SOC threshold, the high SOC threshold being higher than the low SOC threshold; make a third determination regarding whether a battery temperature of the vehicle battery system is greater than a battery temperature threshold; and issue the first command to the VICM to route the regenerative energy from the vehicle electric motor operating as the generator of the regenerative energy to power the vehicle battery cooling system based on the first, second, and third determinations.

In at least one embodiment, the low SOC threshold is 10%, the high SOC threshold is 90%, and the battery temperature threshold is 30° C.

In at least one embodiment, the at least one memory further includes instructions that upon execution by the at least one processor, causes the at least one processor to: make the first determination regarding whether the ambient air temperature is greater than the low air temperature threshold and less than the high ambient air temperature threshold; make the second determination regarding whether the SOC of the HV battery is greater than the high SOC threshold; make a fourth determination regarding whether the battery temperature of the vehicle battery system is less than the battery temperature threshold; and issue the first command to the VICM to route the regenerative energy from the vehicle electric motor operating as the generator of the regenerative energy to power the at least one vehicle accessory system based on the first, second and fourth determinations.

In at least one embodiment, the at least one memory further includes instructions that upon execution by the at least one processor, causes the at least one processor to: make a fifth determination regarding whether the ambient air temperature is greater than the low air temperature threshold and less than the high ambient air temperature threshold; make a sixth determination regarding whether the SOC of the HV battery is less than a high SOC threshold, the high SOC threshold being greater than the low SOC threshold; and issue a second command to the VICM to route the regenerative energy from the vehicle electric motor operating as the generator of the regenerative energy to the vehicle battery system to recharge at least one of the HV battery and a low voltage (LV) battery of the vehicle battery system based on the fifth and sixth determinations.

In at least one embodiment, the at least one memory further includes instructions that upon execution by the at least one processor, causes the at least one processor to: determine whether the SOC of the HV battery is less than the low SOC threshold; and issue a third command to the VICM to route the regenerative energy from the vehicle electric motor operating as the generator of the regenerative energy to the vehicle battery system to recharge the HV battery based on the determination.

A method of managing regenerative energy in a vehicle includes: receiving, at a controller, a regenerative energy notification associated with regenerative energy being generated in response to braking of the vehicle using a regenerative braking system from an electronic brake control module (EBCM) of the vehicle; receiving, at the controller, a state of charge (SOC) of a high voltage (HV) battery of a vehicle battery system from the vehicle battery system; determining, by the controller, whether the SOC of the HV battery is greater than a low SOC threshold; and issuing, by the controller, a first command to a vehicle integration control module (VICM) to route the regenerative energy from a vehicle electric motor operating as a generator of the regenerative energy to power at least one of a vehicle heating, ventilation, and cooling (HVAC) system, a vehicle battery cooling system, and at least one vehicle accessory system based on the determination.

In at least one embodiment, the method further includes: receiving, at the controller, an ambient air temperature from a sensor system of the vehicle; determining, by the controller, whether the ambient air temperature is less than a low ambient air temperature threshold or greater than a high ambient air temperature threshold, the high ambient air temperature threshold being higher than the low ambient air temperature threshold; and issuing, by the controller, the first command to the VICM to route the regenerative energy from the vehicle electric motor operating as the generator of the regenerative energy to power the vehicle HVAC system based on the determination.

In at least one embodiment, the method further includes: making a first determination, by the controller, regarding whether the ambient air temperature is greater than the low air temperature threshold and less than the high ambient air temperature threshold; making a second determination, by the controller, regarding whether the SOC of the HV battery is greater than a high SOC threshold, the high SOC threshold being higher than the low SOC threshold; making a third determination, by the controller, regarding whether a battery temperature of the vehicle battery system is greater than a battery temperature threshold; and issuing the first command, by the controller, to the VICM to route the regenerative energy from the vehicle electric motor operating as the generator of the regenerative energy to power the vehicle battery cooling system based on the first, second, and third determinations.

In at least one embodiment, the low SOC threshold is 10%, the high SOC threshold is 90%, and the battery temperature threshold is 30° C.

In at least one embodiment, the method further includes: making, by the controller, the first determination regarding whether the ambient air temperature is greater than the low air temperature threshold and less than the high ambient air temperature threshold; making, by the controller, the second determination regarding whether the SOC of the HV battery is greater than the high SOC threshold; making, by the controller, a fourth determination regarding whether the battery temperature of the vehicle battery system is less than the battery temperature threshold; and issuing, by the controller, the first command to the VICM to route the regenerative energy from the vehicle electric motor operating as the generator of the regenerative energy to power the at least one vehicle accessory system based on the first, second and fourth determinations.

In at least one embodiment, the method further includes making, by the controller, a fifth determination regarding whether the ambient air temperature is greater than the low air temperature threshold and less than the high ambient air temperature threshold; making a sixth determination, by the controller, regarding whether the SOC of the HV battery is less than a high SOC threshold, the high SOC threshold being greater than the low SOC threshold; and issuing a second command, by the controller, to the VICM to route the regenerative energy from the vehicle electric motor operating as the generator of the regenerative energy to the vehicle battery system to recharge at least one of the HV battery and a low voltage (LV) battery of the vehicle battery system based on the fifth and sixth determinations.

In at least one embodiment, the method further includes: determining, by the controller, whether the SOC of the HV battery is less than the low SOC threshold; and issuing, by the controller, a third command to the VICM to route the regenerative energy from the vehicle electric motor operating as the generator of the regenerative energy to the vehicle battery system to recharge the HV battery based on the determination.

A vehicle including a regenerative energy management system includes at least one processor and at least one memory communicatively coupled to the at least one processor. The at least one memory includes instructions that upon execution by the at least one processor, causes the at least one processor to: receive a regenerative energy notification associated with regenerative energy being generated in response to braking of the vehicle using a regenerative braking system from an electronic brake control module (EBCM) of the vehicle; receive a state of charge (SOC) of a high voltage (HV) battery of a vehicle battery system from the vehicle battery system; determine whether the SOC of the HV battery is greater than a low SOC threshold; and issue a first command to a vehicle integration control module (VICM) to route the regenerative energy from a vehicle electric motor operating as a generator of the regenerative energy to power at least one of a vehicle heating, ventilation, and cooling (HVAC) system, a vehicle battery cooling system, and at least one vehicle accessory system based on the determination.

In at least one embodiment, the at least one memory further includes instructions that upon execution by the at least one processor, causes the at least one processor to: receive an ambient air temperature from a sensor system of the vehicle; determine whether the ambient air temperature is less than a low ambient air temperature threshold or greater than a high ambient air temperature threshold, the high ambient air temperature threshold being higher than the low ambient air temperature threshold; and issue the first command to the VICM to route the regenerative energy from the vehicle electric motor operating as the generator of the regenerative energy to power the vehicle HVAC system based on the determination.

In at least one embodiment, the at least one memory further includes instructions that upon execution by the at least one processor, causes the at least one processor to: make a first determination regarding whether the ambient air temperature is greater than the low air temperature threshold and less than the high ambient air temperature threshold; make a second determination regarding whether the SOC of the HV battery is greater than a high SOC threshold, the high SOC threshold being higher than the low SOC threshold; make a third determination regarding whether a battery temperature of the vehicle battery system is greater than a battery temperature threshold; and issue the first command to the VICM to route the regenerative energy from the electric motor operating as the generator of the regenerative energy to power the vehicle battery cooling system based on the first, second, and third determinations.

In at least one embodiment, the at least one memory further includes instructions that upon execution by the at least one processor, causes the at least one processor to: make the first determination regarding whether the ambient air temperature is greater than the low air temperature threshold and less than the high ambient air temperature threshold; make the second determination regarding whether the SOC of the HV battery is greater than the high SOC threshold; make a fourth determination regarding whether the battery temperature of the vehicle battery system is less than the battery temperature threshold; and issue the first command to the VICM to route the regenerative energy from the vehicle electric motor operating as the generator of the regenerative energy to power the at least one vehicle accessory system based on the first, second and fourth determinations.

In at least one embodiment, the at least one memory further includes instructions that upon execution by the at least one processor, causes the at least one processor to: make a fifth determination regarding whether the ambient air temperature is greater than the low air temperature threshold and less than the high ambient air temperature threshold; make a sixth determination regarding whether the SOC of the HV battery is less than a high SOC threshold, the high SOC threshold being greater than the low SOC threshold; and issue a second command to the VICM to route the regenerative energy from the vehicle electric motor operating as the generator of the regenerative energy to the vehicle battery system to recharge at least one of the HV battery and a low voltage (LV) battery of the vehicle battery system based on the fifth and sixth determinations.

In at least one embodiment, the at least one memory further includes instructions that upon execution by the at least one processor, causes the at least one processor to: determine whether the SOC of the HV battery is less than the low SOC threshold; and issue a third command to the VICM to route the regenerative energy from the vehicle electric motor operating as the generator of the regenerative energy to the vehicle battery system to recharge the HV battery based on the determination.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle including a regenerative energy management system in accordance with at least one embodiment;

FIG. 2 is a functional block diagram of a controller including a regenerative energy management system in accordance with at least one embodiment; and

FIG. 3 is a flowchart representation of an exemplary method of managing regenerative energy in accordance with at least one embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

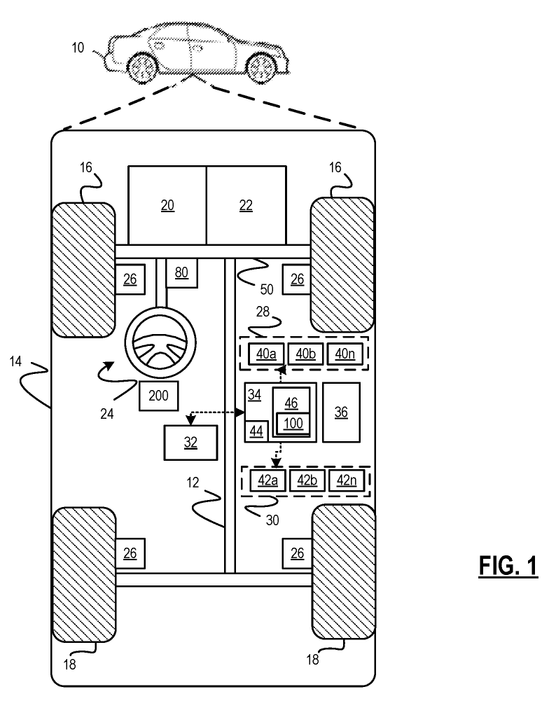

Referring to FIG. 1, a functional block diagram of a vehicle 10 including a regenerative energy management system 100 in accordance with at least one embodiment is shown. The vehicle 10 generally includes a chassis 12, a body 14, front wheels 16, and rear wheels 18. While the vehicle 10 is depicted in the illustrated embodiment as a passenger car, the vehicle 10 may be other types of vehicles including trucks, sport utility vehicles (SUVs), and recreational vehicles (RVs).

In various embodiments, the body 14 is arranged on the chassis 12 and substantially encloses components of the vehicle 10. The body 14 and the chassis 12 may jointly form a frame. The wheels 16, 18 are each rotationally coupled to the chassis 12 near a respective corner of the body 14.

In various embodiments, the vehicle 10 is an autonomous or semi-autonomous vehicle that is automatically controlled to carry passengers and/or cargo from one place to another. For example, in an exemplary embodiment, the vehicle 10 is a so-called Level Two, Level Three, Level Four or Level Five automation system. Level two automation means the vehicle assists the driver in various driving tasks with driver supervision. Level three automation means the vehicle can take over all driving functions under certain circumstances. All major functions are automated, including braking, steering, and acceleration. At this level, the driver can fully disengage until the vehicle tells the driver otherwise. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. In at least one embodiment, the vehicle 10 does not have any automation capability.

As shown, the vehicle 10 generally includes a propulsion system 20 a transmission system 22, a steering system 24, a braking system 26, a sensor system 28, an actuator system 30, at least one data storage device 32, at least one controller 34, and a communication system 36. The controller 34 is configured to implement an automated driving system (ADS). The propulsion system 20 is configured to generate power to propel the vehicle. In at least one embodiment, the propulsion system 20 includes an internal combustion engine (ICE). The propulsion system 20, in various embodiments, include an electric machine such as a traction motor, a fuel cell propulsion system, and/or any other type of propulsion configuration. The transmission system 22 is configured to transmit power from the propulsion system 20 to the vehicle wheels 16, 18 according to selectable speed ratios. According to various embodiments, the transmission system 22 may include a step-ratio automatic transmission, a continuously-variable transmission, or other appropriate transmission. The braking system 26 is configured to provide braking torque to the vehicle wheels 16, 18. The braking system 26 may, in various embodiments, include friction brakes, brake by wire, a regenerative braking system such as an electric machine, and/or other appropriate braking systems. In at least one embodiment, for regenerative braking, at least one electric motor/generator is connected to at least one axle via mechanical shafts and gears

The steering system 24 is configured to influence a position of the of the vehicle wheels 16. While depicted as including a steering wheel and steering column, for illustrative purposes, in some embodiments contemplated within the scope of the present disclosure, the steering system 24 may not include a steering wheel and/or steering column. The steering system 24 includes a steering column coupled to an axle 50 associated with the front wheels 16 through, for example, a rack and pinion or other mechanism (not shown). Alternatively, the steering system 24 may include a steer by wire system that includes actuators associated with each of the front wheels 16.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, a steering wheel sensor, and/or other sensors.

The vehicle dynamics sensors provide vehicle dynamics data including longitudinal speed, yaw rate, lateral acceleration, longitudinal acceleration, etc. The vehicle dynamics sensors may include wheel sensors that measure information pertaining to one or more wheels of the vehicle 10. In one embodiment, the wheel sensors comprise wheel speed sensors that are coupled to each of the wheels 16, 18 of the vehicle 10. Further, the vehicle dynamics sensors may include one or more accelerometers (provided as part of an Inertial Measurement Unit (IMU)) that measure information pertaining to an acceleration of the vehicle 10. In various embodiments, the accelerometers measure one or more acceleration values for the vehicle 10, including latitudinal and longitudinal acceleration and yaw rate. In at least one embodiment, the vehicle dynamic sensors provide vehicle location and vehicle movement data.

The actuator system 30 includes one or more actuator devices 42a-42n that control one or more vehicle features such as, but not limited to, one or more vehicle wheels 16, 18 the propulsion system 20, the transmission system 22, the steering system 24, and the braking system 26. In various embodiments, the vehicle features can further include interior and/or exterior vehicle features such as, but are not limited to, doors, a trunk, and cabin features such as air, music, lighting, etc. (not numbered).

The communication system 36 is configured to wirelessly communicate information to and from other entities 48, such as but not limited to, other vehicles (vehicle to vehicle, “V2V” communication,) infrastructure (vehicle to infrastructure “V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in the ADS of the vehicle 10. In various embodiments, the data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10. In at least one embodiment, the computer-readable storage device 46 is at least one memory configured to store the regenerative energy management system 100.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10. In various embodiments, the controller(s) 34 are configured to implement ADS.

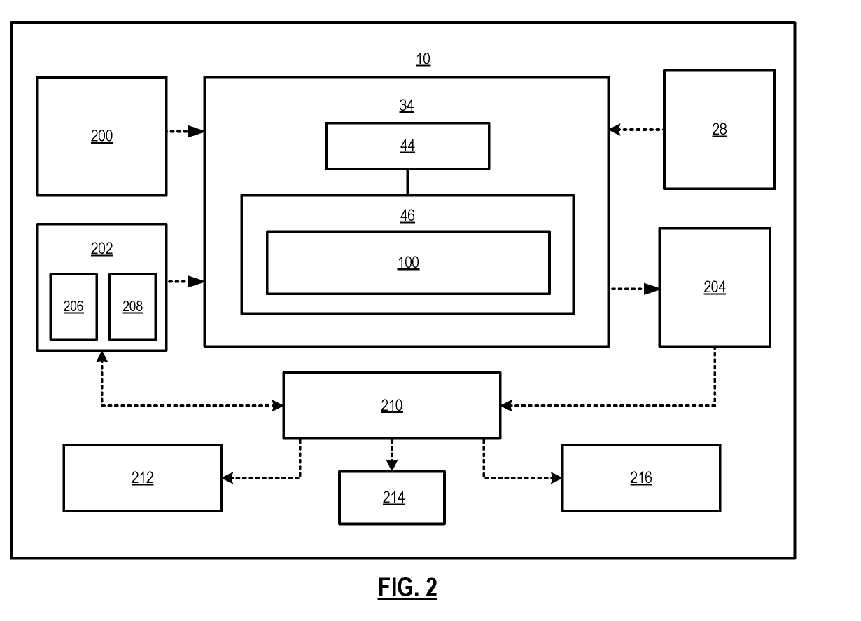

Referring to FIG. 2, a functional block diagram of a controller 34 including a regenerative energy management system 100 in accordance with at least one embodiment is shown. The controller 34 includes at least one processor 44 and at least one memory 46. The at least one processor 44 is a programable device that includes one or more instructions stored in or associated with the at least one memory 46. The at least one memory 46 includes instructions that the at least one processor 44 is configured to execute. The at least one memory 46 includes an embodiment of the regenerative energy management system 100.

The controller 34 is configured to be communicatively coupled to an electronic brake control module (EBCM) 200, a vehicle battery system 202, a sensor system 28, and a vehicle integration control module (VICM) 204. The EBCM 200 is configured to manage the braking system 26 of the vehicle 10. The braking system 26 is configured to provide braking torque to the vehicle wheels 16, 18. The braking system 26 includes a friction braking system and a regenerative braking system. The vehicle battery system 202 includes a high voltage (HV) battery 206 and a low voltage (LV) battery 208. The sensor system 28 includes an ambient air temperature sensor. The VICM 204 is configured to be communicatively coupled to a vehicle electric motor 210.

The vehicle electric motor 210 is a component of the propulsion system 20 and is configured to propel the vehicle 10. When the regenerative braking system is employed, the kinetic energy of the moving vehicle 10 is captured by the vehicle electric motor 210. The vehicle electric motor 210 operates as a generator and converts the kinetic energy into regenerative energy (electrical energy). The vehicle electric motor 210 reverses its function from supplying power to drive the vehicle wheels 16, 18 to a generator that generates regenerative energy when at least a portion of the braking is implemented via the regenerative braking system. The vehicle electric motor 210 is electrically coupled to the HV battery 206 and the LV battery 208 of the vehicle battery system 202, a vehicle battery cooling system 212, a vehicle heating, ventilation, and cooling (HVAC) system 214, and one or more vehicle accessory systems 216. The vehicle electric motor 210 is configured to distribute the regenerative energy to the HV battery 204 and the LV battery 206 of the vehicle battery system 202, a vehicle battery cooling system 212, a vehicle heating, ventilation, and cooling (HVAC) system 214, and one or more vehicle accessory systems 216 in response to a control strategy implemented by the regenerative energy management system 100.

The regenerative energy management system 100 is configured to manage the distribution of the regenerative energy generated by the vehicle electric motor 210 when the vehicle electric motor 210 is operating as a generator. The regenerative energy management system 100 is configured to route the regenerative energy to the HV battery 204 and the LV battery 206 of the vehicle battery system 202, the vehicle battery cooling system 212, the vehicle HVAC system 214, and one or more vehicle accessory systems 216. The controller 34 may include additional components that facilitate operation of the regenerative energy management system 100. The operation of the regenerative energy management system 100 will be described in greater detail below. In at least one embodiment, the controller 34 may be referred to as the regenerative energy management system 100.

The LV battery 206, the vehicle battery cooling system 212, the HVAC system 214, and the one or more vehicle accessory systems 216 (i.e. non-propulsion loads) typically draw electrical power from the HV battery 204. During regenerative braking, the electrical power returned by the vehicle electric motor 210 in generating mode can be used to selectively to reduce the HV battery draw of these systems, allow them to increase power momentarily during the regenerative braking period, and to charge the HV battery 204. The selection of one or more of the options is determined by an optimal energy management strategy, which determines the most efficient combination. The optimal energy management strategy is implemented by the regenerative energy management system 100.

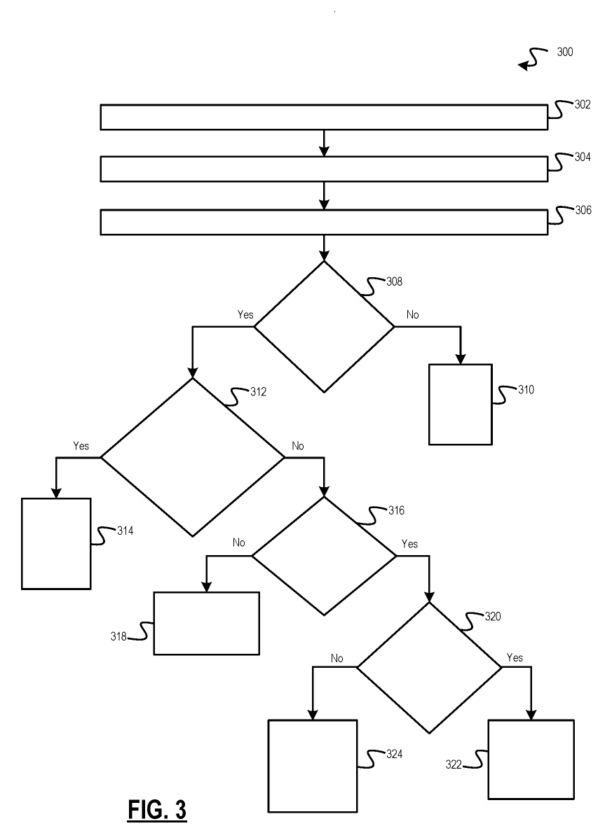

Referring to FIG. 3, a flowchart representation of an exemplary method 300 of managing regenerative energy in accordance with at least one embodiment is shown. The method 300 will be described with reference to an exemplary implementation of an embodiment of a regenerative energy management system 100. As can be appreciated in light of the disclosure, the order of operation within the method 300 is not limited to the sequential execution as illustrated in FIG. 3 but may be performed in one or more varying orders as applicable and in accordance with the present disclosure.

At 302, an EBCM 200 initiates of braking of a vehicle 10 using a regenerative braking system of the braking system 26. In at least one embodiment, the EBCM 200 coordinates initiation of the braking of the vehicle 10 in response to a detected brake pedal position of a brake pedal of the vehicle 10. In at least one embodiment, the EBCM 200 coordinates initiation of the braking of the vehicle 10 in response to a detected change in an acceleration pedal position of an acceleration pedal of the vehicle 10. For example, the detected change in the acceleration pedal position may be associated with easing off the acceleration pedal resulting in a deceleration of the vehicle 10. In at least one embodiment, the EBCM 200 coordinates initiation of the braking of the vehicle 10 in response to a detected pulling back of a regeneration on demand paddle on a steering wheel 24 of the vehicle 10. In at least one embodiment, the EBCM 200 coordinates initiation of the braking of the vehicle 10 in response to detection of a combination of a change in the acceleration pedal position of the acceleration pedal and a pulling back of the regeneration on demand paddle on the steering wheel 24.

The braking system 26 includes a friction braking system and a regenerative braking system. If the braking is initiated in response to detection of an obstacle that the vehicle 10 is at risk of contacting, the EBCM 200 coordinates the braking of the vehicle 10 using just the friction braking system. There is no regenerative energy generated by the vehicle electric motor 200 when only the friction braking system is employed and the method 300 is not implemented.

If the braking is initiated in a situation where there is no risk of contact between the vehicle 10 and an obstacle, the EBCM 200 coordinates braking of the vehicle 10 using the regenerative braking system or a combination of the friction braking system and the regenerative braking system and the method 300 progresses to 304. Since the regenerative braking system is used, the vehicle electric motor 200 operates as a generator of regenerative energy.

At 304, the regenerative energy management system 100 receives a regenerative energy notification indicating that regenerative energy is being generated by the vehicle electric motor 210. The EBCM 200 generates and transmits the regenerative energy notification to the controller 34 including the regenerative energy management system 100 upon initiation of the use of the regenerative braking system in the braking of the vehicle 10.

At 306, the regenerative energy management system 100 receives a state of charge (SOC) of the HV battery 206 from the vehicle battery system 202. At 308, the regenerative energy management system 100 determines whether the SOC of the HV battery 206 is greater than a low SOC threshold. An example of a low SOC threshold is 10%.

If the regenerative energy management system 100 determines that the SOC of the HV battery 206 is not greater than the low SOC threshold (i.e. the SOC of the HV battery 206 is less than the low SOC threshold), the regenerative energy management system 100 issues a command to the VICM 204 to route the regenerative energy from the vehicle electric motor 210 operating as a generator of the regenerative energy to charge the HV battery 206 of the vehicle battery system 202 at 310.

If the regenerative energy management system 100 determines that the SOC of the HV battery 206 is greater than the low SOC threshold, the regenerative energy management system 100 determines whether an ambient air temperature is less than a low ambient air temperature threshold or greater than a high ambient air temperature threshold at 312. The high ambient air temperature threshold is higher than the low ambient air temperature. The regenerative energy management system 100 receives the ambient air temperature from the sensor system 28 of the vehicle 10. The sensor system 28 includes an ambient air temperature sensor that is configured to sense the temperature of the ambient air outside the vehicle 10.

An ambient air temperature that is less than the low ambient air temperature threshold indicates that an in-cabin temperature within the vehicle 10 may be below a comfort level temperature for the occupants of the vehicle 10 and the heating system of the vehicle HVAC system 214 is automatically activated to heat the in-cabin environment. If the regenerative energy management system 100 determines that ambient air temperature is less than the low ambient air temperature threshold, the regenerative energy management system 100 issues a command to the VICM 204 to route the regenerative energy from the vehicle electric motor 210 operating as the generator of the regenerative energy to power the vehicle HVAC system 214 to heat the in-cabin environment using the heating system of the vehicle HVAC system 214 at 314.

An ambient air temperature that is above the a high ambient air temperature threshold indicates that an in-cabin temperature within the vehicle 10 may be above a comfort level temperature for the occupants of the vehicle 10 and the cooling system of the vehicle HVAC system 214 is automatically activated to cool the in-cabin environment. If the regenerative energy management system 100 determines that ambient air temperature is greater than the high ambient air temperature threshold, the regenerative energy management system 100 issues a command to the VICM 204 to route the regenerative energy from the vehicle electric motor 210 operating as the generator of the regenerative energy to power the vehicle HVAC system 214 to cool the in-cabin environment using the cooling system of the vehicle HVAC system 214 at 314.

If the regenerative energy management system 100 determines that the ambient air temperature is greater than the low ambient air temperature threshold and lower than the high ambient air temperature threshold, the regenerative energy management system 100 determines whether the SOC of the HV battery 206 of the vehicle battery system 202 is greater than a high SOC threshold at 316. The high SOC threshold is higher than the low SOC threshold. An example of the high SOC threshold is 90%.

In at least one embodiment, if the regenerative energy management system 100 determines that the SOC of the HV battery 206 of the vehicle battery system 202 is not greater than the high SOC threshold (i.e. the SOC of the HV battery 206 is less than the high SOC threshold), the regenerative energy management system 100 issues a command to the VICM 204 to route the regenerative energy from the vehicle electric motor 210 operating as the generator of the regenerative energy to route the regenerative energy to a LV battery 208 of the vehicle battery system 202 at 318.

In at least one embodiment, if the regenerative energy management system 100 determines that the SOC of the HV battery 206 of the vehicle battery system 202 is not greater than the high SOC threshold (i.e. the SOC of the HV battery 206 is less than the high SOC threshold), the regenerative energy management system 100 issues a command to the VICM 204 to route the regenerative energy from the vehicle electric motor 210 operating as the generator of the regenerative energy to route the regenerative energy to the HV battery 206 of the vehicle battery system 202 at 318.

In at least one embodiment, if the regenerative energy management system 100 determines that the SOC of the HV battery 206 of the vehicle battery system 202 is not greater than the high SOC threshold (i.e. the SOC of the HV battery 206 is less than the high SOC threshold), the regenerative energy management system 100 issues a command to the VICM 204 to route the regenerative energy from the vehicle electric motor 210 operating as the generator of the regenerative energy to route the regenerative energy to both the LV battery 208 and the HV battery 206 of the vehicle battery system 202 at 318.

If the regenerative energy management system 100 determines that the SOC of the HV battery 206 is greater than the high SOC threshold, the regenerative energy management system 100 determines whether a battery temperature of the vehicle battery system 202 is greater than a battery temperature threshold at 320. In at least one embodiment, the vehicle battery system 202 includes the HV battery 206. In at least one embodiment, the vehicle battery system 202 includes the LV battery 208. In at least one embodiment, the vehicle battery system 202 includes both the HV battery 206 and the LV battery 208. The regenerative energy management system 100 receives the battery temperature from at least one battery temperature sensor of the vehicle battery system 202. An example of a battery temperature threshold is 30° C.

If the regenerative energy management system 100 determines that the battery temperature of the vehicle battery system 202 is greater than the battery temperature threshold, the regenerative energy management system 100 issues a command to the VICM 204 to route the regenerative energy from the vehicle electric motor 210 operating as the generator of the regenerative energy to power a vehicle battery cooling system 212 at 322. The vehicle battery cooling system 212 is configured to automatically cool the vehicle battery system 202 when the battery temperature of the vehicle battery system 202 rises above the battery temperature threshold.

If the regenerative energy management system 100 determines that the battery temperature of the vehicle battery system 202 is not greater than the battery temperature threshold (i.e. the battery temperature of the vehicle battery system 202 is less than the battery temperature threshold), the regenerative energy management system 100 issues a command to the VICM 204 to route the regenerative energy from the vehicle electric motor 210 operating as the generator of the regenerative energy to power at least one vehicle accessory system 216 at 324. Examples of vehicle accessory systems include, but are not limited to, power windows, power door locks, an infotainment system, heated seats, a navigation system, and vehicle display systems.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A regenerative energy management system for a vehicle, comprising:
at least one processor; and
at least one memory communicatively coupled to the at least one processor, the at least one memory comprising instructions that upon execution by the at least one processor, causes the at least one processor to:
receive a regenerative energy notification associated with regenerative energy being generated in response to braking of the vehicle using a regenerative braking system from an electronic brake control module (EBCM) of the vehicle;
receive a state of charge (SOC) of a high voltage (HV) battery of a vehicle battery system from the vehicle battery system;
determine whether the SOC of the HV battery is greater than a low SOC threshold; and
issue a first command to a vehicle integration control module (VICM) to route the regenerative energy from a vehicle electric motor operating as a generator of the regenerative energy to power at least one of a vehicle heating, ventilation, and cooling (HVAC) system, a vehicle battery cooling system, and at least one vehicle accessory system based on the determination.

2. The system of claim 1, wherein the at least one memory further comprises instructions that upon execution by the at least one processor, causes the at least one processor to:
receive an ambient air temperature from a sensor system of the vehicle;
determine whether the ambient air temperature is less than a low ambient air temperature threshold or greater than a high ambient air temperature threshold, the high ambient air temperature threshold being higher than the low ambient air temperature threshold; and
issue the first command to the VICM to route the regenerative energy from the vehicle electric motor operating as the generator of the regenerative energy to power the vehicle HVAC system based on the determination.

3. The system of claim 2, wherein the at least one memory further comprises instructions that upon execution by the at least one processor, causes the at least one processor to:
make a first determination regarding whether the ambient air temperature is greater than the low air temperature threshold and less than the high ambient air temperature threshold;
make a second determination regarding whether the SOC of the HV battery is greater than a high SOC threshold, the high SOC threshold being higher than the low SOC threshold;
make a third determination regarding whether a battery temperature of the vehicle battery system is greater than a battery temperature threshold; and
issue the first command to the VICM to route the regenerative energy from the vehicle electric motor operating as the generator of the regenerative energy to power the vehicle battery cooling system based on the first, second, and third determinations.

4. The system of claim 3, wherein the low SOC threshold is 10%, the high SOC threshold is 90%, and the battery temperature threshold is 30° C.

5. The system of claim 3, wherein the at least one memory further comprises instructions that upon execution by the at least one processor, causes the at least one processor to:
make the first determination regarding whether the ambient air temperature is greater than the low air temperature threshold and less than the high ambient air temperature threshold;
make the second determination regarding whether the SOC of the HV battery is greater than the high SOC threshold;
make a fourth determination regarding whether the battery temperature of the vehicle battery system is less than the battery temperature threshold; and
issue the first command to the VICM to route the regenerative energy from the vehicle electric motor operating as the generator of the regenerative energy to power the at least one vehicle accessory system based on the first, second and fourth determinations.

6. The system of claim 2, wherein the at least one memory further comprises instructions that upon execution by the at least one processor, causes the at least one processor to:
make a fifth determination regarding whether the ambient air temperature is greater than the low air temperature threshold and less than the high ambient air temperature threshold;
make a sixth determination regarding whether the SOC of the HV battery is less than a high SOC threshold, the high SOC threshold being greater than the low SOC threshold; and
issue a second command to the VICM to route the regenerative energy from the vehicle electric motor operating as the generator of the regenerative energy to the vehicle battery system to recharge at least one of the HV battery and a low voltage (LV) battery of the vehicle battery system based on the fifth and sixth determinations.

7. The system of claim 1, wherein the at least one memory further comprises instructions that upon execution by the at least one processor, causes the at least one processor to:
determine whether the SOC of the HV battery is less than the low SOC threshold; and
issue a third command to the VICM to route the regenerative energy from the vehicle electric motor operating as the generator of the regenerative energy to the vehicle battery system to recharge the HV battery based on the determination.

8. A method of managing regenerative energy in a vehicle comprising:
receiving, at a controller, a regenerative energy notification associated with regenerative energy being generated in response to braking of the vehicle using a regenerative braking system from an electronic brake control module (EBCM) of the vehicle;
receiving, at the controller, a state of charge (SOC) of a high voltage (HV) battery of a vehicle battery system from the vehicle battery system;
determining, by the controller, whether the SOC of the HV battery is greater than a low SOC threshold; and
issuing, by the controller, a first command to a vehicle integration control module (VICM) to route the regenerative energy from a vehicle electric motor operating as a generator of the regenerative energy to power at least one of a vehicle heating, ventilation, and cooling (HVAC) system, a vehicle battery cooling system, and at least one vehicle accessory system based on the determination.

9. The method of claim 8, further comprising:
receiving, at the controller, an ambient air temperature from a sensor system of the vehicle;
determining, by the controller, whether the ambient air temperature is less than a low ambient air temperature threshold or greater than a high ambient air temperature threshold, the high ambient air temperature threshold being higher than the low ambient air temperature threshold; and
issuing, by the controller, the first command to the VICM to route the regenerative energy from the vehicle electric motor operating as the generator of the regenerative energy to power the vehicle HVAC system based on the determination.

10. The method of claim 9, further comprising:
making a first determination, by the controller, regarding whether the ambient air temperature is greater than the low air temperature threshold and less than the high ambient air temperature threshold;
making a second determination, by the controller, regarding whether the SOC of the HV battery is greater than a high SOC threshold, the high SOC threshold being higher than the low SOC threshold;
making a third determination, by the controller, regarding whether a battery temperature of the vehicle battery system is greater than a battery temperature threshold; and
issuing the first command, by the controller, to the VICM to route the regenerative energy from the vehicle electric motor operating as the generator of the regenerative energy to power the vehicle battery cooling system based on the first, second, and third determinations.

11. The method of 10, wherein the low SOC threshold is 10%, the high SOC threshold is 90%, and the battery temperature threshold is 30° C.

12. The method of claim 10, further comprising:
making, by the controller, the first determination regarding whether the ambient air temperature is greater than the low air temperature threshold and less than the high ambient air temperature threshold;
making, by the controller, the second determination regarding whether the SOC of the HV battery is greater than the high SOC threshold;
making, by the controller, a fourth determination regarding whether the battery temperature of the vehicle battery system is less than the battery temperature threshold; and
issuing, by the controller, the first command to the VICM to route the regenerative energy from the vehicle electric motor operating as the generator of the regenerative energy to power the at least one vehicle accessory system based on the first, second and fourth determinations.

13. The method of claim 9, further comprising:
making, by the controller, a fifth determination regarding whether the ambient air temperature is greater than the low air temperature threshold and less than the high ambient air temperature threshold;
making a sixth determination, by the controller, regarding whether the SOC of the HV battery is less than a high SOC threshold, the high SOC threshold being greater than the low SOC threshold; and
issuing a second command, by the controller, to the VICM to route the regenerative energy from the vehicle electric motor operating as the generator of the regenerative energy to the vehicle battery system to recharge at least one of the HV battery and a low voltage (LV) battery of the vehicle battery system based on the fifth and sixth determinations.

14. The method of claim 8, further comprising:
determining, by the controller, whether the SOC of the HV battery is less than the low SOC threshold; and
issuing, by the controller, a third command to the VICM to route the regenerative energy from the vehicle electric motor operating as the generator of the regenerative energy to the vehicle battery system to recharge the HV battery based on the determination.

15. A vehicle including a regenerative energy management system comprising:
at least one processor; and
at least one memory communicatively coupled to the at least one processor, the at least one memory comprising instructions that upon execution by the at least one processor, causes the at least one processor to:
receive a regenerative energy notification associated with regenerative energy being generated in response to braking of the vehicle using a regenerative braking system from an electronic brake control module (EBCM) of the vehicle;
receive a state of charge (SOC) of a high voltage (HV) battery of a vehicle battery system from the vehicle battery system;
determine whether the SOC of the HV battery is greater than a low SOC threshold; and
issue a first command to a vehicle integration control module (VICM) to route the regenerative energy from a vehicle electric motor operating as a generator of the regenerative energy to power at least one of a vehicle heating, ventilation, and cooling (HVAC) system, a vehicle battery cooling system, and at least one vehicle accessory system based on the determination.

16. The vehicle of claim 15, wherein the at least one memory further comprises instructions that upon execution by the at least one processor, causes the at least one processor to:
receive an ambient air temperature from a sensor system of the vehicle;
determine whether the ambient air temperature is less than a low ambient air temperature threshold or greater than a high ambient air temperature threshold, the high ambient air temperature threshold being higher than the low ambient air temperature threshold; and
issue the first command to the VICM to route the regenerative energy from the vehicle electric motor operating as the generator of the regenerative energy to power the vehicle HVAC system based on the determination.

17. The vehicle of claim 16, wherein the at least one memory further comprises instructions that upon execution by the at least one processor, causes the at least one processor to:
make a first determination regarding whether the ambient air temperature is greater than the low air temperature threshold and less than the high ambient air temperature threshold;
make a second determination regarding whether the SOC of the HV battery is greater than a high SOC threshold, the high SOC threshold being higher than the low SOC threshold;
make a third determination regarding whether a battery temperature of the vehicle battery system is greater than a battery temperature threshold; and
issue the first command to the VICM to route the regenerative energy from the electric motor operating as the generator of the regenerative energy to power the vehicle battery cooling system based on the first, second, and third determinations.

18. The vehicle of claim 17, wherein the at least one memory further comprises instructions that upon execution by the at least one processor, causes the at least one processor to:
make the first determination regarding whether the ambient air temperature is greater than the low air temperature threshold and less than the high ambient air temperature threshold;
make the second determination regarding whether the SOC of the HV battery is greater than the high SOC threshold;
make a fourth determination regarding whether the battery temperature of the vehicle battery system is less than the battery temperature threshold; and
issue the first command to the VICM to route the regenerative energy from the vehicle electric motor operating as the generator of the regenerative energy to power the at least one vehicle accessory system based on the first, second and fourth determinations.

19. The vehicle of claim 16, wherein the at least one memory further comprises instructions that upon execution by the at least one processor, causes the at least one processor to:
make a fifth determination regarding whether the ambient air temperature is greater than the low air temperature threshold and less than the high ambient air temperature threshold;
make a sixth determination regarding whether the SOC of the HV battery is less than a high SOC threshold, the high SOC threshold being greater than the low SOC threshold; and
issue a second command to the VICM to route the regenerative energy from the vehicle electric motor operating as the generator of the regenerative energy to the vehicle battery system to recharge at least one of the HV battery and a low voltage (LV) battery of the vehicle battery system based on the fifth and sixth determinations.

20. The vehicle of claim 15, wherein the at least one memory further comprises instructions that upon execution by the at least one processor, causes the at least one processor to receive the regenerative energy notification, the regenerative energy notification being generated by the EBCM in response to at least one of a detected brake pedal position of a brake pedal of the vehicle, a detected change in an acceleration pedal position of an acceleration pedal of the vehicle, a detected pulling back of a regeneration on demand paddle on a steering wheel of the vehicle, and a detected combination of a change in the acceleration pedal position of the acceleration pedal and a pulling back of the regeneration on demand paddle on the steering wheel.
